(19) United States
(12) Patent Application Publication
(10) Pub. No.: US 2004/0265150 A1
(43) Pub. Date: Dec. 30, 2004

(54) Magnetic membrane system

(75) Inventors: Michael W. McElfresh, Livermore, CA (US); Matthew S. Lucas, Pasadena, CA (US)

Correspondence Address: Eddie E. Scott, Assistant Laboratory Counsel, Lawrence Livermore National Loboratory, P.O. Box 808, L-703, Livermore, CA, 94551, US

(73) Assignee: The Regents of the University of California

(21) Appl. No.: 10/857,571

(22) Filed: May 28, 2004

Related U.S. Application Data
(60) Provisional application No. 60/474,981, filed on May 30, 2003.

(51) Int. Cl. F04B 1/00; F15B 5/00

(52) U.S. Cl. 417/413.1; 251/129.01; 251/331; 417/53; 137/416; 417/413.2

(57) ABSTRACT

The present invention provides a membrane with magnetic particles. In one embodiment the membrane is created by mixing particles in a non-magnetic base. The membrane may act as an actuator, a sensor, a pump, a valve, or other device. A magnet is operatively connected to the membrane. The magnet acts on and changes the shape of the membrane.

### CROSS-REFERENCE TO RELATED APPLICATIONS

This application claims the benefit of U.S. Provisional Patent Application No. 60/474,981 filed May 30, 2003 and titled “Magnet and Magnetic Membrane for Various Applications.” U.S. Provisional Patent Application No. 60/474,981 filed May 30, 2003 and titled “Magnet and Magnetic Membrane for Various Applications” is incorporated herein by this reference.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to membranes and more particularly to a membrane with magnetic particles.

2. State of Technology

U.S. patent application No. 2004/0021073 to Mladen Barbic, Jack J. Mock, and Andrew P. Gray published Feb. 5, 2004 and assigned to California Institute of Technology for apparatus and method for magnetic-based manipulation of microscopic particles, provides the following state of technology information, “Micromanipulation and characterization of objects ranging in size from atomic to micrometer dimensions has become one of the central features of modern science. Optical trapping methods are known for manipulating latex micron-sized balls attached to objects of biological interest at room temperature. In addition, systems based on carbon nanotubes have been utilized for physical tweezing of micro-objects. Miniaturizing mechanical, optical, magnetic, and electronic components is part of a major effort in development and use of micro- and nano-scale devices and systems. For example, there has been a significant amount of micro-electromechanical systems (MEMS) research with the goal of reducing the size of systems into sub-millimeter dimensions. As part of the development and operation of these miniaturized systems, it is highly desired to provide methods and systems for manipulating very small (micro- or nano-scale, for example) particles in various environments, including air, vacuum, or fluid. As an example, there exists a specific interest in the manipulation of magnetic objects. Magnetic tweezers have found wide uses in biological applications, such as in the investigations of the physical properties of the cytoplasm, mechanical properties of cell surfaces, and elasticity and transport of single DNA molecules. For cell studies, most of these techniques rely on the micromanipulation of a magnetic particle positioned inside a cell wall or bound on the surface of a cell, while the single molecule investigations involve linking the magnetic particle on one end of the molecule strand. In all of these studies, micromanipulation is performed with a device consisting of permanent or soft coil-wound magnets with macroscopic dimensions. Typical forces available through these techniques are in the range of 0.1-10 pN.”

U.S. patent application No. 2002/0075108 to Lester G. Ward and Howard Weinstein published Jun. 20, 2002 for method of remotely actuating a membrane switch by attractive or repulsive magnetic force, provides the following state of technology information, “a magnetic force for assisting in the actuation process. A magnet positioned adjacent to the membrane switch causes a magnetic attraction or repulsion that remotely transfers a limited but sufficient force for closing the membrane switch. The invention includes a magnet, a membrane switch, and an actuator constructed of a magnetically-affected material.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides a membrane with magnetic particles. In one embodiment the membrane is created by mixing particles in a non-magnetic base. The membrane may act as an actuator, a sensor, a pump, a valve, or other device. A magnet is operatively connected to the membrane. The magnet acts on and changes the shape of the membrane. In various embodiments, the membrane is controlled by a surrounding magnetic field. The magnetic field may can be created using a permanent magnet or an electromagnet or by both. The present invention also provides a method of actuating a device to perform an activity on a subject comprising the steps of providing a membrane having magnetic pieces in a nonmagnetic material body, positioning the membrane in a desired position with regard to the subject, and using a magnet to produce a magnetic field that acts on the magnetic pieces thereby actuating the device to perform the activity on the subject.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 illustrates a magnetic membrane constructed in accordance with the present invention.

FIG. 2 illustrates an embodiment of the present invention acting as an actuator.

FIG. 3 illustrates another embodiment of the present invention acting as an actuator.

FIG. 4 illustrates an embodiment of the present invention acting as a sensor.

FIG. 5 illustrates another embodiment of the present invention acting as a sensor.

FIG. 6 illustrates an embodiment of the present invention acting as a magnetically actuated orifice.

FIG. 7 illustrates another embodiment of the present invention acting as a magnetically actuated orifice.

FIG. 8 illustrates another embodiment of the present invention acting as a magnetically actuated orifice.

FIG. 9 illustrates another embodiment of the present invention acting as a magnetically actuated orifice.

FIG. 10 illustrates an embodiment of the present invention acting as acting as a pump.

FIG. 11 illustrates an embodiment of the present invention acting as acting as a pump.

FIG. 12 illustrates an embodiment of the present invention acting as acting as a valve.

FIG. 13 illustrates an embodiment of the present invention acting as acting as a valve.

### DETAILED DESCRIPTION OF THE INVENTION

Referring now to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

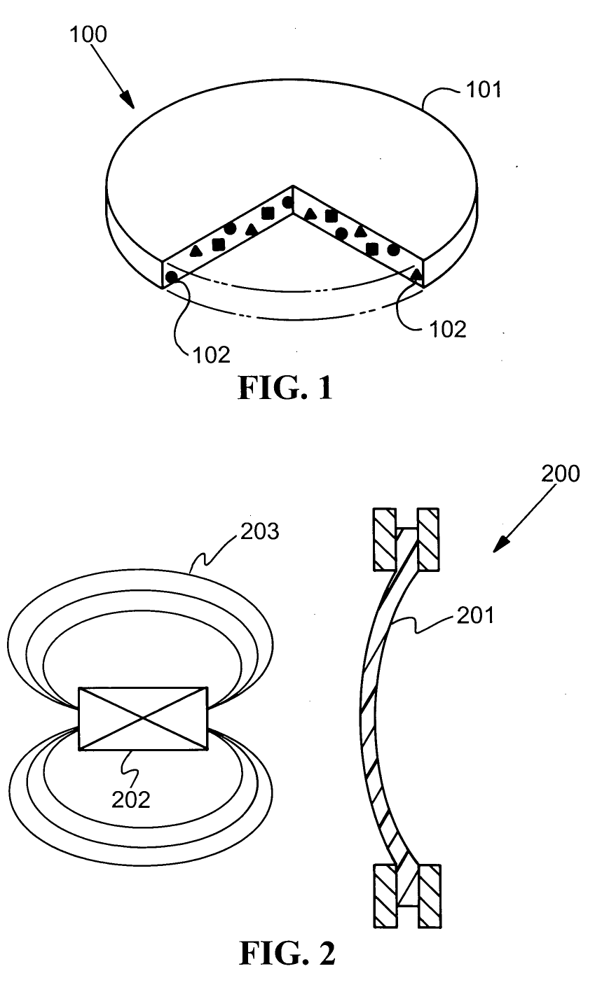

Referring now to FIG. 1, one embodiment of a membrane using embedded particles constructed in accordance with the present invention is illustrated. The figure is an illustration of the components and is not intended to be an accurate representation of the proportion of the components. This embodiment is designated generally by the reference numeral 100.

A magnetic actuation membrane 100 was created by mixing particles 103 in a non-magnetic base 101. By embedding magnetic particles 103 into a non-magnetic base 101 it becomes possible to actuate a device. The non-magnetic base 101 in the embodiment 100 is Sylgaurd 184. However, any non-magnetic media may be used in consideration to the desired properties. The weight fraction of particles 103 to non-magnetic base 101 is variable and based on the system specifications. The particles 103 may be dispersed uniformly or in a specific concentration profile depending on the application. The domair of the particles 103 may also be aligned by curing in the presence of a magnetic field. The magnetic particles 103 may be paramagnetic, or super-magnetic, or permanent magnetic.

Substantially any nonmagnetic material can be used for the non-magnetic base 101. In the embodiment 100, for the non-magnetic base 101 is Sylgaurd 184. Substantially any magnetic particles can be used for the particles 103. For example, the following specific embodiments show different particles 103. In one embodiment the magnetic pieces 102 comprise a Ni—Pd alloy. In another the magnetic pieces 102 comprise a Fe—Pt alloy. In yet another embodiment the magnetic pieces 102 comprise a Ni—Zn—Fe—O magnetic powder. In one embodiment the magnetic pieces 102 comprise a Ba—Co—Fe—O magnetic powder. In another embodiment the magnetic pieces 102 comprise a Fe—O magnetic powder. The magnetic pieces 102 can comprise a substituted magnetite or ferric oxide crystalline lattice with a portion of the iron atoms substituted by one of the following, cobalt, nickel, manganese, zinc, magnesium, copper, chromium, cadmium, or gallium. In one embodiment the magnetic pieces 102 comprise a Palladium Cobalt alloy. In another embodiment the magnetic pieces 102 comprise a Palladium Cobalt alloy that has a controllable curie temperature in the range of 40-100 degrees Celsius. In yet another embodiment the magnetic pieces 102 comprise a Nickel Zinc Ferrite material. In still another embodiment the magnetic pieces 102 comprise particles having a size range of 1 nm to 500 microns.

The membrane 100 may act as an actuator, a sensor, a pump, a valve, or other device. As an actuator the membrane is controlled by the surrounding magnetic field. The magnetic field may be created using a permanent magnet or an electromagnet or by both. The magnetic field is controlled by the shape of the permanent magnet or the configuration of the electromagnet, which is determined by modeling techniques. As a sensor the membrane 100 contains permanent magnetic particles. When a force is applied to the membrane it will deform. A nearby magnetic field sensor, either optical or electrical, is used to monitor the changing field.

Referring now to FIG. 2, an embodiment of the present invention illustrates a system 200 acting as an actuator. A membrane 201 contains magnetic particles in a non-magnetic base as previously described. There are uses for the system 200, for example, the membrane 201 can be use to impart pulses to a fluid. The membrane 201 is controlled by a surrounding magnetic field 203. The magnetic field 203 is created using a permanent magnet 202. In one embodiment, the magnetic field 203 is controlled by the shape of the permanent magnet 202. In another embodiment, the magnetic field 203 is controlled by movement of the permanent magnet 202.

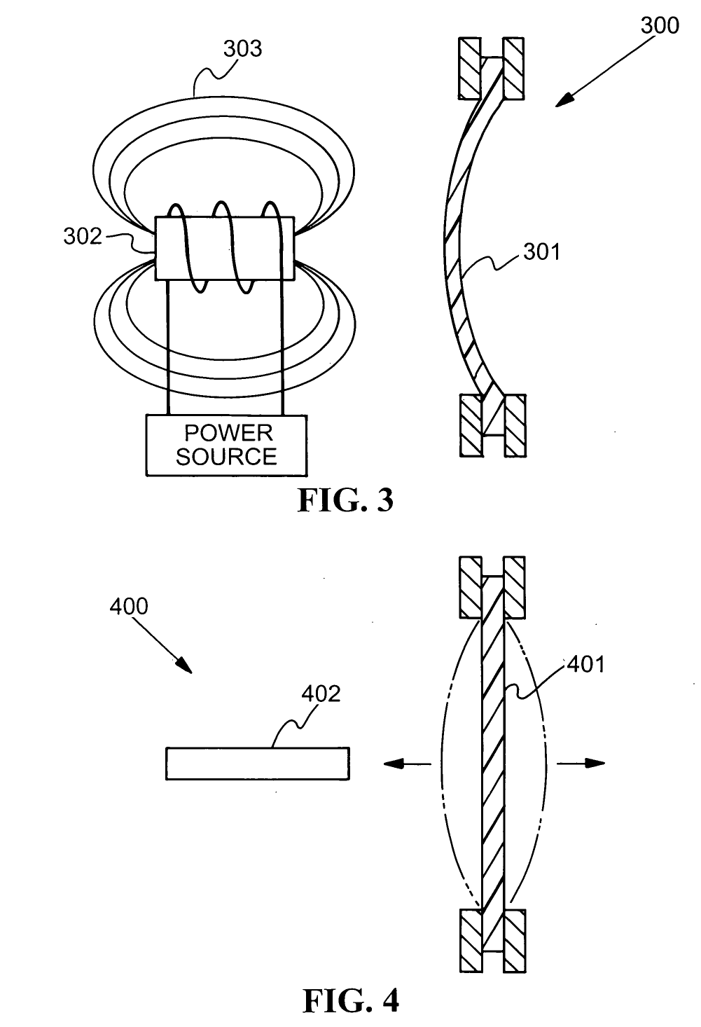

Referring now to FIG. 3, another embodiment of the present invention illustrates a system 300 acting as an actuator. A membrane 301 contains magnetic particles in a non-magnetic base as previously described. There are uses for the system 300, for example, the membrane 201 can be use to impart pulses to a fluid. The membrane 301 is controlled by a surrounding magnetic field 303. The magnetic field 303 is created using an electromagnet 302. The magnetic field 303 in one embodiment is controlled by the configuration of the electromagnet 302, which is determined by modeling techniques.

Referring now to FIG. 4, another embodiment of the present invention illustrates a system 400 acting as a sensor. A membrane 401 contains permanent magnetic particles. The membrane 401 is produced by embedding permanent particles in a non-magnetic base as illustrated in FIG. 1. When a force is applied to the membrane 401, the membrane 401 will deform. A nearby magnetic field sensor 402 is used to monitor the changing field produced by movement of the membrane 401. The magnetic field sensor 402 can be either an optical or electrical magnetic field sensor. With the ability to measure displacement, the system 400 can be used as a pressure gauge, in sonar applications, as an accelerometer, etc.

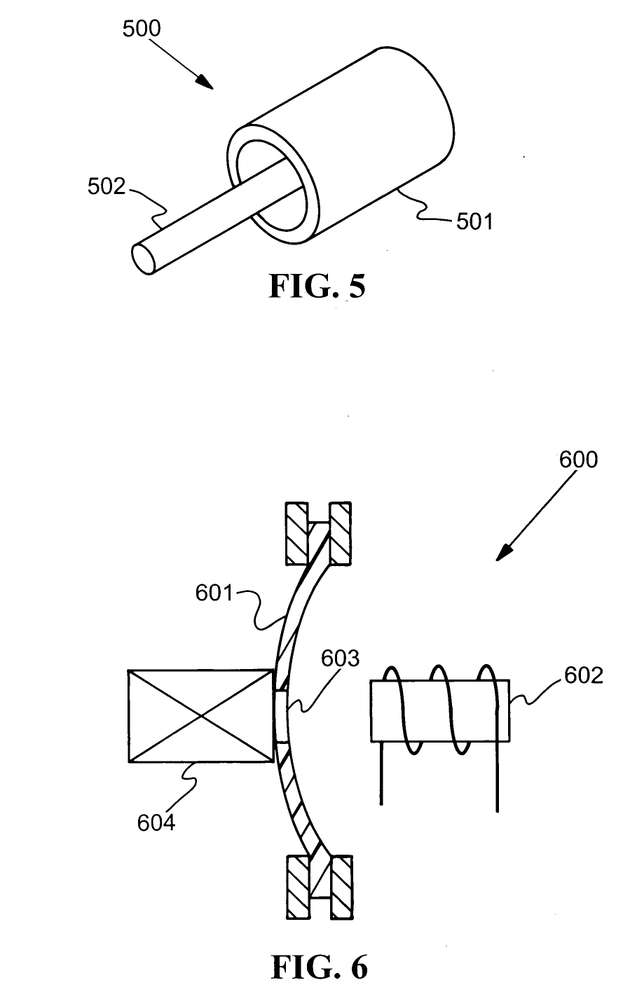

Referring now to FIG. 5, another embodiment of the present invention illustrates a system 500 acting as a sensor. A membrane 501 contains permanent magnetic particles. The membrane 501 is produced by embedding permanent particles in a non-magnetic base as illustrated in FIG. 1. The membrane 501 is formed in a tubular shape. When a force is applied to the membrane 501, the membrane 501 will deform. A magnetic field sensor 502 is used to monitor the changing field produce d by movement of the membrane 501. The magnetic field sensor 502 is positioned within the tubular shaped membrane 501. The magnetic field sensor 502 can be either an optical or electrical magnetic field sensor. With the ability to measure displacement, the system 500 can be used as a pressure gauge, in sonar applications, as an accelerometer, etc.

Referring now to FIG. 6, another embodiment of the present invention illustrates a system 600 acting as a magnetically actuated orifice. The system 600 comprises a membrane 601 with a hole 603 in the membrane 601. The membrane 601 is produced by embedding permanent particles in a non-magnetic base as illustrated in FIG. 1. The controlled orifice system 600 consists of the hole 603 in the membrane 601 in the presence of a magnetic device including a permanent magnet 604 and an electromagnet 602. The controlled orifice system 600 is shown in normally closed state in FIG. 6 and consists of a permanent magnet 604, an electromagnet 602, and the membrane 601 with a hole 603 in it. When the electromagnet 602 is off the hole 603 is closed, as shown in FIG. 6.

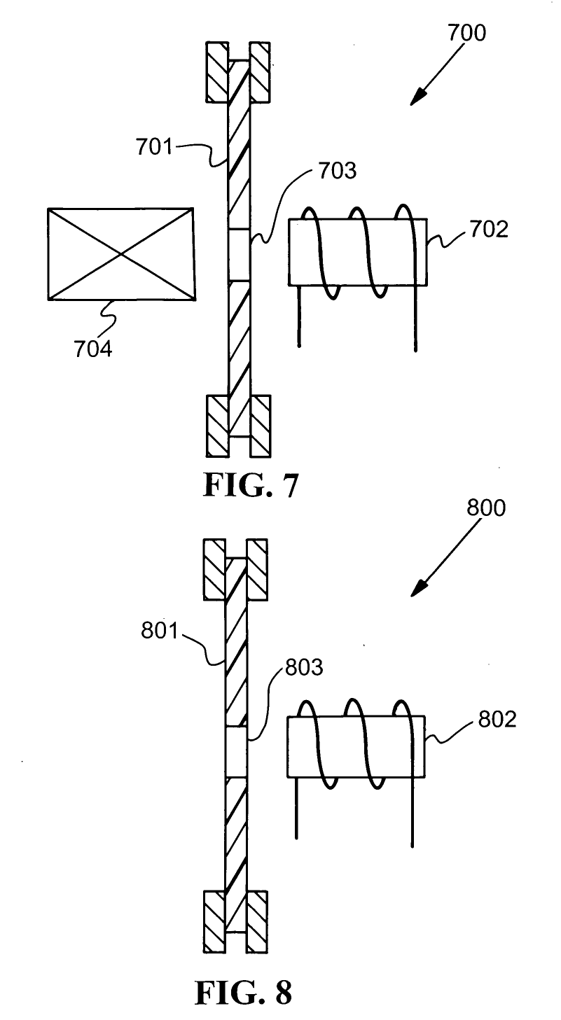

Referring now to FIG. 7, another embodiment of the present invention illustrates a system 700 acting as a magnetically actuated orifice. The system 700 comprises a membrane 701 with a hole 703 in the membrane 701. The membrane 701 is produced by embedding permanent particles in a non-magnetic base as illustrated in FIG. 1. The controlled orifice system 700 consists of the hole 703 in the membrane 701 in the presence of a magnetic device including a permanent magnet 704 and an electromagnet 702. The controlled orifice system 700 is shown with the hole 703 in the open state. This is compared with the system 600 of FIG. 6 shown with the hole 603 in the closed state. The controlled orifice system 700 is operated by applying a counteracting magnetic field with the electromagnet 702.

Referring now to FIG. 8, another embodiment of the present invention illustrates a system 800 acting as a magnetically actuated orifice. The magnetically actuated orifice system 800 comprises a membrane 801 with a hole 803 in the membrane 801. The membrane 801 is produced by embedding permanent particles in a non-magnetic base as illustrated in FIG. 1. The controlled orifice system 800 consists of the hole 803 in the membrane 801 in the presence of an electromagnet 802. The controlled orifice system 800 is shown with the hole 803 in the open state. The normally open state consists of only the electromagnet 802 in the vicinity of the membrane 801. When the electromagnet 802 is off the hole 803 remains open.

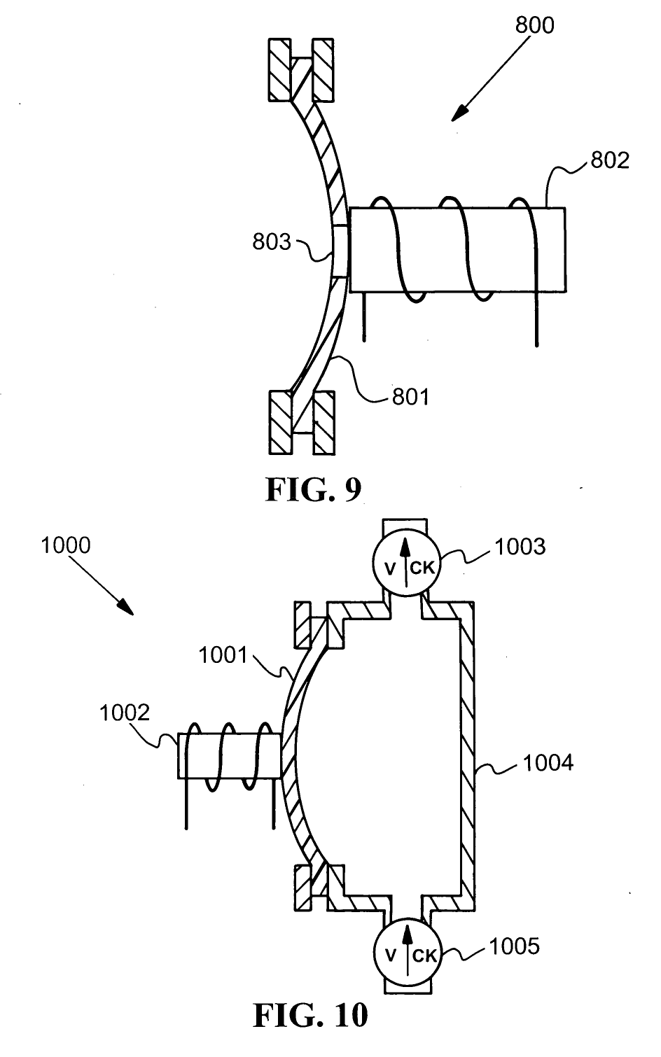

Referring now to FIG. 9, the system 800 acting as a magnetically actuated orifice illustrated in FIG. 8 is shown with the electromagnet 802 and the hole 803 closed. The controlled orifice system 800 consists of only the electromagnet 802 in the vicinity of the membrane 801. When the electromagnet 802 is off the hole 803 remains open. When the electromagnet 802 is on, the hole closes, as shown in FIG. 9.

Referring now to FIGS. 10 and 11, an embodiment of the present invention illustrates a system acting as a pump. The system is designated generally by the reference numeral 1000. The system 1000 includes a valve body 1004, a one way intake valve 1005, a one way out put valve 1003, a membrane 1001, and an electromagnet 1002. The membrane 1001 contains magnetic particles in a non-magnetic base as previously described.

The pump 1000 in the intake mode is illustrated in FIG. 10. The electromagnet 1001 is turned on and fluid 1006 is drawn in through one way intake valve 1005 into the valve body 1004. The membrane 1001 is controlled by a magnetic field created by the electromagnet 1002. When a force is applied to the membrane 1001, the membrane 1001 will deform and draw the fluid in through one way intake valve 1005 into the valve body 1004.

The pump 1000 in the output mode is illustrated in FIG. 11. The electromagnet 1001 is turned off and fluid 1006 is expelled through one way out put valve 1003 from the valve body 1004. The a one way intake valve 1005 blocks flow of the fluid out of the valve body 1004 through valve 1005 insuring that the fluid is expelled through one way out put valve 1003 from the valve body 1004.

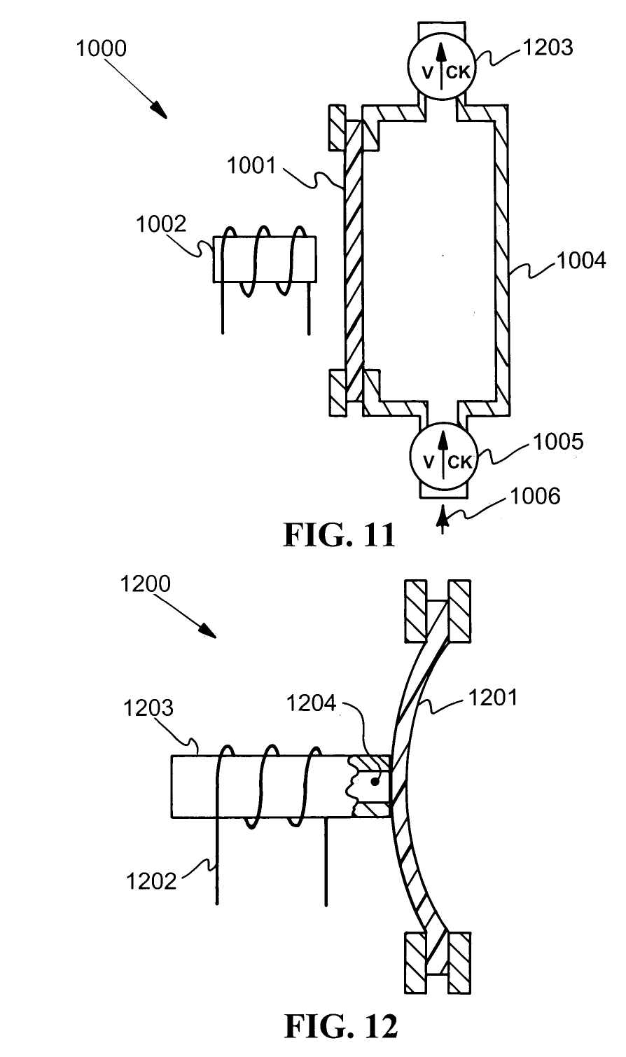

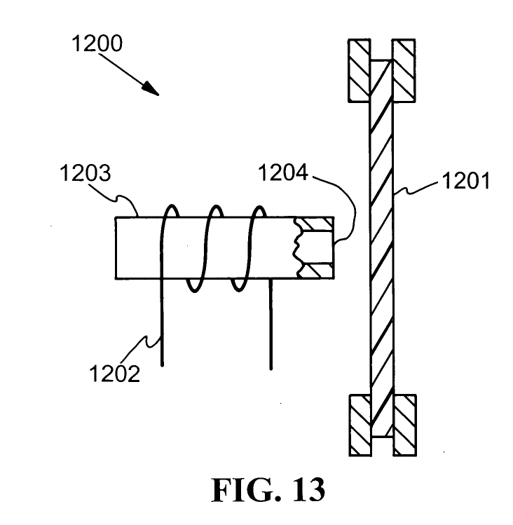

Referring now to FIGS. 12 and 13, an embodiment of the present invention illustrates a system acting as a valve. The system is designated generally by the reference numeral 1200. The system 1200 includes a membrane 1201 and an electromagnet 1202. The membrane 1201 contains magnetic particles in a non-magnetic base as previously described.

The valve 1200 in the closed position is illustrated in FIG. 12. The electromagnet 1001 is turned on and membrane 12001 is drawn into a position where it closes the opening 1204 in a pipe 1203. The membrane 1201 is controlled by a magnetic field created by the electromagnet 1202. When a force is applied to the membrane 1201, the membrane 1201 will deform and close the opening 1204 in the pipe 1203.

The valve 1200 in the open position is illustrated in FIG. 13. The electromagnet 1001 is turned off and membrane 12001 relaxes to a position where it has moved from the opening 1204 in a pipe 1203. This opens the valve and allows flow through the pipe 1203. The membrane 1201 is controlled by a magnetic field created by the electromagnet 1202. When a force is applied to the membrane 1201, the membrane 1201 will deform and close the opening 1204 in the pipe 1203. When the electromagnet 1001 is turned off, the membrane 1201 relaxes to a position where it is moved away from the opening 1204 in a pipe 1203 and allows flow of fluid through the pipe 1203.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. An apparatus, comprising:
a membrane,
said membrane made of a nonmagnetic material body and
magnetic pieces, said magnetic pieces contained in said nonmagnetic material body,
a magnet operatively connected to said membrane, and
means for causing said magnet to act on and change the shape of said membrane.

2. The apparatus of claim 1 wherein said magnet is a permanent magnet.

3. The apparatus of claim 1 wherein said magnet is an electro magnet.

4. The apparatus of claim 1 wherein said nonmagnetic material body comprises a polymer material.

5. The apparatus of claim 1 wherein said nonmagnetic material body comprises a polymeric material.

6. The apparatus of claim 1 wherein said magnetic pieces comprise individual magnetic particles.

7. The apparatus of claim 1 wherein said magnetic pieces are magnetic particles embedded in said nonmagnetic material body.

8. The apparatus of claim 1 wherein said magnetic pieces are magnetic particles dispersed uniformly in said nonmagnetic material body.

9. The apparatus of claim 1 wherein said magnetic pieces are magnetic particles in a specific concentration profile in said nonmagnetic material body.

10. The apparatus of claim 1 wherein said magnetic pieces comprise a Fe—Pt alloy.

11. The apparatus of claim 1 wherein said magnetic pieces comprise a Ni—Pd alloy.

12. The apparatus of claim 1 wherein said magnetic pieces comprise a Ni—Zn—Fe—O magnetic powder.

13. The apparatus of claim 1 wherein said magnetic pieces comprise a Bad-Co—Fe—O magnetic powder.

14. The apparatus of claim 1 wherein said magnetic pieces comprise a Fe—O magnetic powder.

15. The apparatus of claim 1 wherein said magnetic pieces comprise a substituted magnetite or ferric oxide crystalline lattice with a portion of the iron atoms substituted by one of the following, cobalt, nickel, manganese, zinc, magnesium, copper, chromium, cadmium, or gallium.

16. The apparatus of claim 1 wherein said magnetic pieces comprise a Palladium Cobalt alloy.

17. The apparatus of claim 1 wherein said magnetic pieces comprise a Palladium Cobalt alloy that has a controllable curie temperature in the range of 40-100 degrees Celsius.

18. The apparatus of claim 1 wherein said magnetic pieces comprise a Nickel Zinc Ferrite material.

19. The apparatus of claim 1 wherein said magnetic pieces comprise particles having a size range of 1 nm to 500 microns.

20. The apparatus of claim 1 including a magnetic field sensor operatively connected to said membrane.

21. The apparatus of claim 1 including a tubular magnetic field sensor operatively connected to said membrane.

22. The apparatus of claim 1 including a pump body operatively connected to said membrane and valve means connected to said pump body for controlling flow.

23. The apparatus of claim 1 including a pump body operatively connected to said membrane, a one way intake valve connected to said pump body, and a one way output valve connected to said pump body.

24. The apparatus of claim 1 where said apparatus serves as a valve to open or close a conduit with an opening with said membrane positioned to move between a position closing said opening and a position where said opening is not closed.

25. An apparatus, comprising:
a membrane,
said membrane made of a nonmagnetic material body and
magnetic pieces, said magnetic pieces contained in said nonmagnetic material body, and
magnet means operatively connected to said membrane for causing said membrane to change shape.

26. The apparatus of claim 1 wherein said magnet means is a permanent magnet.

27. The apparatus of claim 1 wherein said magnet means is an electro magnet.

28. The apparatus of claim 1 wherein said nonmagnetic material body comprises a polymer material.

29. The apparatus of claim 1 wherein said nonmagnetic material body comprises a polymeric material.

30. The apparatus of claim 1 wherein said magnetic pieces comprise individual magnetic particles.

31. The apparatus of claim 1 wherein said magnetic pieces are magnetic particles embedded in said nonmagnetic material body.

32. The apparatus of claim 1 wherein said magnetic pieces are magnetic particles dispersed uniformly in said nonmagnetic material body.

33. The apparatus of claim 1 wherein said magnetic pieces are magnetic particles in a specific concentration profile in said nonmagnetic material body.

34. The apparatus of claim 1 wherein said magnetic pieces comprise a Fe—Pt alloy.

35. The apparatus of claim 1 wherein said magnetic pieces comprise a Ni—Pd alloy.

36. The apparatus of claim 1 wherein said magnetic pieces comprise a Ni—Zn—Fe—O magnetic powder.

37. The apparatus of claim 1 wherein said magnetic pieces comprise a Bad-Co—Fe—O magnetic powder.

38. The apparatus of claim 1 wherein said magnetic pieces comprise a Fe—O magnetic powder.

39. The apparatus of claim 1 wherein said magnetic pieces comprise a substituted magnetite or ferric oxide crystalline lattice with a portion of the iron atoms substituted by one of the following, cobalt, nickel, manganese, zinc, magnesium, copper, chromium, cadmium, or gallium.

40. The apparatus of claim 1 wherein said magnetic pieces comprise a Palladium Cobalt alloy.

41. The apparatus of claim 1 wherein said magnetic pieces comprise a Palladium Cobalt alloy that has a controllable curie temperature in the range of 40-100 degrees Celsius.

42. The apparatus of claim 1 wherein said magnetic pieces comprise a Nickel Zinc Ferrite material.

43. The apparatus of claim 1 wherein said magnetic pieces comprise particles having a size range of 1 nm to 500 microns.

44. The apparatus of claim 1 including a magnetic field sensor operatively connected to said membrane.

45. The apparatus of claim 1 including a tubular magnetic field sensor operatively connected to said membrane.

46. The apparatus of claim 1 including a pump body operatively connected to said membrane and valve means connected to said pump body for controlling flow.

47. The apparatus of claim 1 including a pump body operatively connected to said membrane, a one way intake valve connected to said pump body, and a one way output valve connected to said pump body.

48. The apparatus of claim 1 where said apparatus serves as a valve to open or close a conduit with an opening with said membrane positioned to move between a position closing said opening and a position where said opening is not closed.

49. A method of actuating a device to perform an activity on a subject, comprising the steps of:
providing a membrane having magnetic pieces in a nonmagnetic material body,
positioning said membrane in a desired position with regard to said subject, and
using a magnet to produce a magnetic field that acts on said magnetic pieces thereby actuating the device to perform the activity on the subject.

50. The method of claim 49 wherein said step of using a magnet comprises using a permanent magnet to produce a magnetic field that acts on said magnetic pieces thereby actuating the device to perform the activity on the subject.

51. The method of claim 49 wherein said step of using a magnet comprises using an electro magnet to produce a magnetic field that acts on said magnetic pieces thereby actuating the device to perform the activity on the subject.

52. The method of claim 49 wherein said step of providing a membrane comprises providing a membrane having magnetic pieces in a polymer material body.

53. The method of claim 49 wherein said step of providing a membrane comprises providing a membrane having magnetic pieces in a polymeric material body.

54. The method of claim 49 wherein said step of providing a membrane comprises providing a membrane having individual magnetic particles in a nonmagnetic material body.

55. The method of claim 49 wherein said step of providing a membrane comprises providing a membrane having magnetic particles embedded in a nonmagnetic material body.

56. The method of claim 49 wherein said step of providing a membrane comprises providing a membrane by dispersing magnetic particles uniformly in a nonmagnetic material body.

57. The method of claim 49 wherein said step of providing a membrane comprises providing a membrane by dispersing magnetic particles in a specific concentration profile in a nonmagnetic material body.

58. The method of claim 49 wherein said step of providing a membrane comprises providing a membrane having ferrite magnetic pieces in a polymer material body.

59. The method of claim 49 wherein said step of providing a membrane comprises providing a membrane having magnetic pieces made of an alloy in a polymer material body.

60. The method of claim 49 wherein said step of providing a membrane comprises providing a membrane having magnetic pieces in the form of a powder in a polymer material body.
